(19) United States
(12) Patent Application Publication
(10) Pub. No.: US 2011/0277646 A1
(43) Pub. Date: Nov. 17, 2011

(54) DEVICE FOR HOT-MARKING ARTICLES IN CRUDE OR FINISHED GLASS OR IN PLASTIC MATERIAL BY TAMPOGRAPHY

(75) Inventors: Marcel Auger, Vatierville (FR); Régis Binet, Saint Germain Sur Bresle (FR); Johan Benoit, Beauchamps (FR)

(73) Assignee: VERRERIES DU COURVAL, Hodeng-au-Bosc (FR)

(21) Appl. No.: 13/084,790

(22) Filed: Apr. 12, 2011

(30) Foreign Application Priority Data
Apr. 12, 2010 (FR) 10 52739

(51) Int. Cl. B41F 17/00

(52) U.S. Cl. 101/41

(57) ABSTRACT

A device for hot-marking articles in crude or finished glass or in plastic material by tampography is provided. The articles may include at least one screen-printed pattern, characterized in that it comprises at least one deformable pad based on silicone with a hardness comprised 50 and 70 shores, heated to a determined temperature in order to apply a paper film onto the screen-printed pattern of each article.

### CROSS-REFERENCE TO RELATED APPLICATIONS

This application claims the benefit of French Application No. 10 52739 filed Apr. 12, 2010, which is hereby expressly incorporated by reference in its entirety.

### BACKGROUND

1. Field of the Invention

The present invention relates to a device for the hot marking by tampography of articles of any shape in crude or finished glass or in plastic material.

2. Description of the Related Art

For example in the field of perfumery or cosmetics, it is common to produce on crude or finished glass articles, such as for example perfume vials, or on plastic article materials, a decoration with relief and providing a metal aspect of the gold or silver type. The articles generally used may be of different shape, such as for example round, flat oval or any other shape.

In order to produce this type of decorations on glass or plastic articles, the articles are placed in a screen-printing machine which deposits on each article according to a predetermined layout, a sublayer from a suitable ink, such as for example a two-component organic ink or a UV ink.

After laying this sub-layer, the articles are transferred by suitable means in a drying tunnel where they undergo pre-polymerization by which the ink may be sufficiently dried, while leaving it slightly tacky at the surface.

Next, the articles pass into a hot-marking machine for ensuring transfer of a paper film by adherization on the ink deposited beforehand on each article. The paper film is only deposited on the screen-printed patterns.

The articles thus covered with a decoration having a metal relief for example resembling to adhered letters or patterns, are then deposited in a final package.

Up to now, the transfer of the paper film onto the ink was achieved by means of a roller or a plate covered with a layer generally of silicone and the whole was heated to a determined temperature so that the film adhered onto the ink of the pattern.

The main drawback of this type of tampography device lies in the fact that it forms a rigid assembly which is more suitable for articles with a planar shape than for articles of complex shape, such as for example vials.

For this kind of articles, each article has to be displaced under the plate in order to obtain transfer of the film which complicates the installations and does not give the possibility of obtaining a homogeneous and good quality decoration.

### SUMMARY

The object of the invention is therefore to propose a device for hot-marking by tampography, articles of any shape in crude or finished glass or in plastic material, which avoids these drawbacks and which, with simple means to be applied, allows an increase in the production rates, while reducing the rejection rate and obtaining a brighter decoration on the articles.

The object of the invention is a device for hot-marking by tampography articles of any shape in crude or finished glass or in plastic material, said articles including one screen-printed pattern, characterized in that it comprises at least one deformable pad based on flexible silicone with hardness comprised between 50 and 70 shores and heated to a determined temperature in order to apply a paper film on the screen-printed pattern of each article, and in that, after applying said deformable pad on each article, the angle formed between a first tangent to the external surface of the pad and passing through the longitudinal axis of the article on the one hand and a second tangent to the external surface of the article passing through the intersection point of said first tangent with said external surface of the article on the other hand, is comprised between 30 and 70°.

According to other features of the invention,
the angle is comprised between 30 and 45° for an article with an external planar surface,
the angle is comprised between 60 and 70° for an article with a curved external surface,
said at least one deformable pad is displaceable between a first position for bearing upon a heating member in order to bring it to said temperature and a second position for applying said film on the corresponding article,
the device comprises two deformable pads based on silicone with a hardness comprised between 50 and 70 shores and each being alternately displaceable between a first position for bearing upon a heating member in order to bring it to said temperature and a second position for applying said film on the corresponding article,
said at least one deformable pad based on silicone preferably has a hardness of the order of 60 shores,
the temperature of said at least one pad is comprised between 110 and 140° C. and preferably is of the order of 130° C.,
said heating member is formed by a heating metal plate provided with at least one regulated electric resistor,
the temperature of the metal plate is comprised between 200 and 300° C.,
the time for applying said pad on each article is of the order of one second.

### BRIEF DESCRIPTION OF THE DRAWINGS

The invention will be better understood on reading the following description given as an example and made with reference to the appended drawings, wherein:

FIG. 1 is a perspective schematic view of a deformable pad of a device for hot-marking articles by tampography, according to the invention, and

FIG. 2 is an elevational schematic view of an assembly for hot marking by tampography including two deformable pads.

FIGS. 3 and 4 are two diagrams showing the angle formed between the external surfaces of the deformable pad and the article, for an article with a planar and curved external surface, respectively.

### DETAILED DESCRIPTION OF THE EMBODIMENTS

In the figures, a hot-marking device by tampography designated by the general reference 10, and intended to produce on articles 1 in crude or finished glass or on plastic articles, a decoration with relief and providing a brilliant metal aspect of the gold of silver type for example, is illustrated schematically. The articles 1 are for example formed by perfume vials of any shapes, having a surface of variable geometry, such as for example recessed, convex or flat portions or on vials with a spherical shape.

When the articles 1 are transferred by suitable means of a known type, not shown, into the hot-marking device 10, these articles have been subject beforehand to a screen-printing operation in order to deposit on each of them according to a predetermined layout, a sub-layer forming a decoration by means of an ink, such as for example a two-component ink or a UV ink. This type of ink has the advantage of allowing it to be more easily laid than conventional inks.

This ink sub-layer is then pre-polymerized in order to sufficiently dry this ink, while leaving it slightly tacky at the surface.

Following this screen-printing operation, the pattern formed by the ink sub-layer is coated with a paper film by hot tampography.

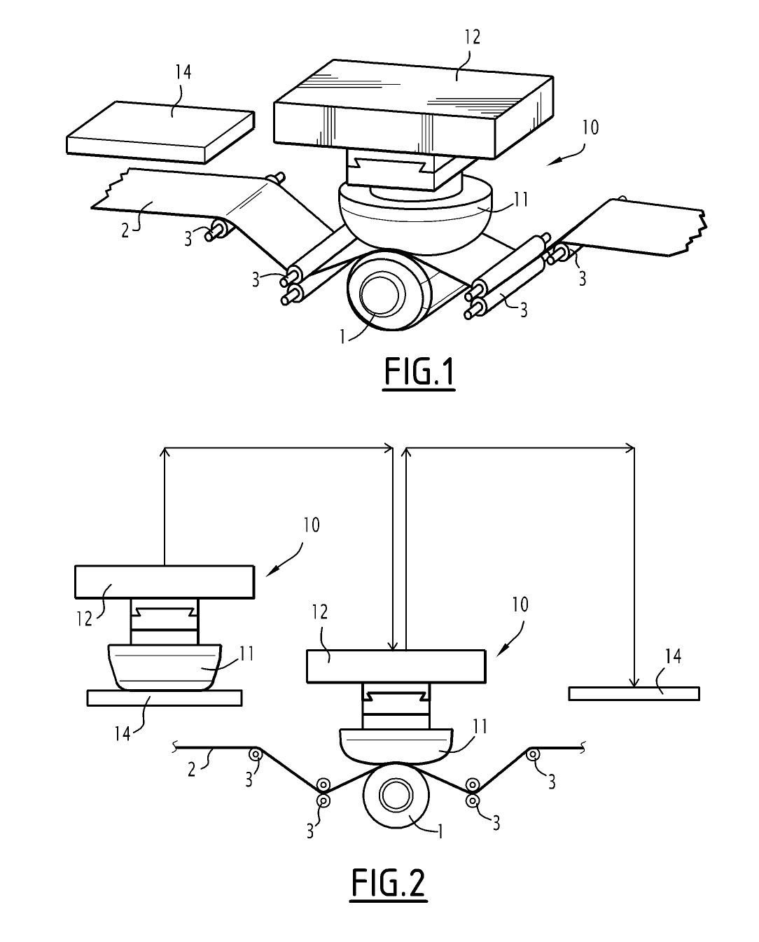

For this and as shown in FIG. 1, the article 1 including the screen-printed pattern is placed below a paper film 2 in order to obtain a decoration with relief and providing a gold or silver brilliant metal aspect, for example resembling to letters or patterns of various shapes, by adherization of this paper film onto the ink deposited beforehand.

The paper film is only deposited on the screen-printed patterns.

The film 2 is guided by rollers 3 in a hot-marking device 10 and displaced stepwise by suitable means of a known type, not shown.

The hot-marking device 10 includes at least one deformable pad 11 in a flexible material and more particularly based on silicone with hardness comprised between 50 and 70 shores and preferably of the order of 60 shores.

The pad 11 is borne by a base 12 connected to means for displacing this pad 11 between a first heating position and a second position for applying the film 2 onto the article 1 by means of said pad 11. The displacement means not shown, are for example formed by a manipulating arm or any other suitable system with which the base 12 bearing the pad 11 may be moved between both positions.

In the first position corresponding to the heating position of the pad 11, this pad 11 bears upon a heating member 14 for bringing it to a determined temperature allowing transfer of the paper film onto the screen-printed pattern of each article 1. This heating member 14 is formed by a heating metal plate provided with at least one regulated electric resistor.

During the application of the pad 11 onto the article 1 for the transfer of the film, the temperature of this pad 11 is comprised between 110 and 140° C. and is of the order of 130° C. When the pad 11 bears upon the heating member 14, the temperature of the metal plate forming this heating member is comprised between 200 and 300° C.

The hot-marking device illustrated in FIG. 1 operates in the following way.

First of all, an article 1 including at least one screen-printed pattern is brought below the paper film 2 and the portion of this article 1 bearing said at least one screen-printed pattern is applied against a portion of said film 2.

The base 12 bearing the pad 11 is brought above the heating member 14 and this pad 11 is applied onto said heating member for a determined time in order to bring it to the desired temperature comprised between 110 and 140° C. and being of the order of 130° C.

The temperature of the heating member 14 is of the order of 200° C. and with the purpose of reducing the time for bringing the pad 11 to the temperature, the heating member temperature 14 may vary between 200 and 300° C.

Next, the pad 11 at the desired temperature borne by the base 12 is placed above the article 1 and is applied on this article 1, a portion of film 2 being interposed between the pad 11 and said article 1, as shown in FIG. 1.

The low hardness of the material making up the pad 11 allows this pad 11 to fit the shape of the article 1. The temperature of the pad 11 allows the ink deposited beforehand on the article 1 to be re-melted at the surface so that the paper film 2 is only deposited on the screen-printed patterns, thereby giving the possibility of obtaining a decoration with metal relief for example resembling to letters or patterns of various shapes. The thereby obtained relief decoration for example has a brilliant metal aspect, of the gold or silver type depending on the film used. The time for applying the pad 11 on the article 1 is of the order of one second.

The base bearing the pad 11 is lifted and the pad 11 is again brought to bear upon the heating member 14 in order to bring it to the desired temperature. The thereby marked article 1 is discharged, the film 2 is advanced by one step and another article bearing at least one screen-printed pattern is placed below the film 2 for a new marking cycle.

In FIG. 2, an assembly for marking articles 1 which are screen-printed beforehand and including two identical hot marking devices 10 is illustrated.

Each device 10 is similar to the device of FIG. 1 and the common elements are designated with the same references.

Thus, each device 10 includes a deformable pad 11 based on flexible silicone with a hardness comprised between 50 and 70 shores and preferably of the order of 60 shores, borne by a base 12 and displaceable by suitable means, not shown, between a first position for bearing upon a heating member 14 in order to bring it to the desired temperature and a second position for applying the film 2 on the screen-printed pattern of the article 1 by flattening said pad 11 against the article 1.

Each pad 11 is alternately displaceable between the first position for bearing upon the corresponding heating member 14 and the second position for applying the film 2 onto an article 1. This alternating displacement of both pads 11 thus allows an increase in the rates for marking the articles 1.

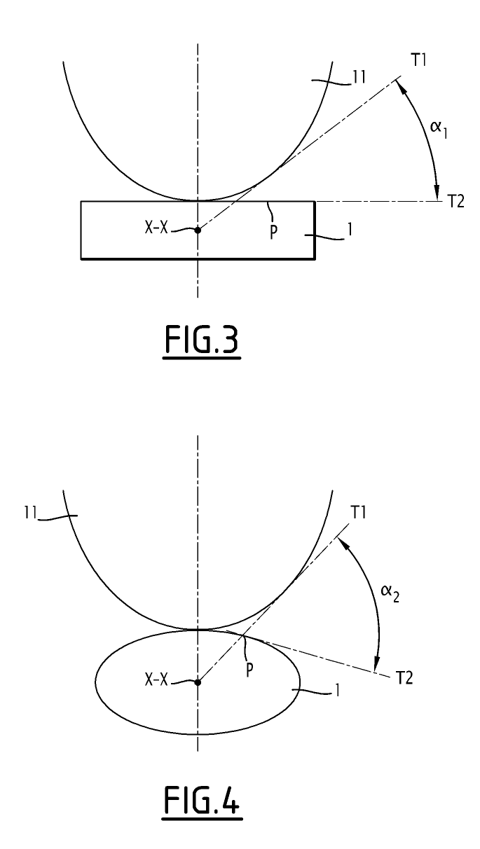

As schematically illustrated in FIGS. 3 and 4, after applying the deformable pad 11 onto the article 1, the angle a1 or a2 formed between a first tangent T1 to the external surface of the pad 11 and passing through the longitudinal axis X-X of the article 1 on the one hand, and a second tangent T2 to the external surface of the article 1 and passing through the intersection point P of said first tangent T1 with said external surface of the article 1 on the other hand, is comprised 30 and 70°.

For an article 1 having a planar external surface, and shown in FIG. 3, the angle a1 is comprised between 30 and 45°.

For an article 1 having a curved external surface, and shown in FIG. 4, the angle a2 is comprised between 60 and 70°.

The device according to the invention for hot-marking articles in crude or finished glass or in plastic material gives the possibility of obtaining a more homogeneous and more brilliant decoration because of the use of a deformable pad based on silicone with low hardness and consequently significantly reducing the rejection rate.

With the device according to the invention, it is possible to do without the shapes and tolerances of the articles, and to carry out hot-marking on articles of any shape having recessed, flat or convex portions or on articles with a spherical shape.

Further because of the flexibility of the silicone making up the pad, the device according to the invention allows application by direct pressure and without any adjustment constraint, while obtaining more relief and better gloss.

What is claimed is:

1. A device for hot-marking articles of any shape in crude or finished glass or in plastic material by tampography, comprising:
at least one deformable pad based on flexible silicone, with a hardness ranging between 50 and 70 shores, heated to a determined temperature in order to apply a paper film onto the screen-printed pattern of each article,
wherein said articles comprise at least one screen-printed pattern, and after applying said deformable pad onto each article, the angle formed between a first tangent to an external surface of the pad and passing through a longitudinal axis of the article on the one hand and a second tangent to an external surface of the article and passing through an intersection point of said first tangent with said external surface of the article on the other hand is between 30 and 70°.

2. The device according to claim 1, wherein, for an article with a planar external surface, the angle is between 30 and 45°.

3. The device according to claim 1, wherein, for an article with a curved external surface, the angle is between 60 and 70°.

4. The device according to claim 1, wherein said at least one deformable pad is displaceable between a first position for bearing upon a heating member in order to bring the pad to said temperature and a second position for applying said film onto the corresponding article.

5. The device according to claim 1, wherein the device comprises two deformable pads based on flexible silicone with a hardness ranging between 50 and 70 shores, each being alternately displaceable between a first position for bearing upon a heating member in order to bring the pad to said temperature and a second position for applying said film onto the corresponding article.

6. The device according to claim 1, wherein said at least one deformable pad based on flexible silicone has a hardness of the order of 60 shores.

7. The device according to claim 1, wherein the temperature of said at least one pad is between 110 and 140° C.

8. The device according to claim 1, wherein the temperature of said at least one pad is of the order of 130° C.

9. The device according to claim 4, wherein said heating member is formed by a heating metal plate provided with at least one regulated electric resistor.

10. The device according to claim 9, wherein the temperature of the metal plate of the heating member is between 200 and 300° C.

11. The device according to claim 1, wherein the time for applying said pad onto each article is of the order of one second.
